(19) United States
(12) Patent Application Publication
(10) Pub. No.: US 2025/0266637 A1
(43) Pub. Date: Aug. 21, 2025

(54) HIGH SPEED, RUGGEDIZED CONNECTOR

(71) Applicant: Amphenol East Asia Electronic Technology (Shenzhen) Co., Ltd., Shenzhen (CN)

(72) Inventors: Koen Maddens, Hofstade (BE); Danren He, Shenzhen (CN); JianQiang Shen, Shenzhen (CN)

(73) Assignee: Amphenol East Asia Electronic Technology (Shenzhen) Co., Ltd., Shenzhen (CN)

(21) Appl. No.: 19/066,841

(22) Filed: Feb. 28, 2025

Related U.S. Application Data
(63) Continuation of application No. PCT/CN2022/115780, filed on Aug. 30, 2022.

(51) Int. Cl. H01R 13/424; H01R 12/72; H01R 13/6581

(52) U.S. Cl. CPC H01R 13/424; H01R 13/6581; H01R 12/722; H01R 2201/26

(57) ABSTRACT

A modular connector that economically provides high signal integrity in a harsh environment, such as an automobile. The connector may include structures that provide precise and stable positioning of conductors with respect to ground structures, even for press fit connectors in which there is a large force on the conductors when mounted to a PCB. Such features may include a multipiece housing for terminal assemblies that holds one or more conductors with transverse portions. The multiple pieces of the housing may slidably engage. One of the pieces may be configured with channels, closed at the top, to slide onto a portion of the conductors and restrain the conductors when the connector is pressed onto a PCB. Other features may include hold-downs with high retention force, and shields with features that precisely and stably position the terminal assemblies with respect to a conductive housing.

### CROSS-REFERENCE TO RELATED APPLICATIONS

This application is a continuation of International Application Serial No. PCT/CN2022/115780, filed on Aug. 30, 2022, entitled “HIGH SPEED, RUGGEDIZED CONNECTOR.” The contents of this application are incorporated herein by reference in their entirety.

### BACKGROUND

This patent application relates generally to interconnection systems, such as those including electrical connectors, used to interconnect electronic assemblies, and more specifically to interconnection systems for harsh environments, such as in a vehicle.

Electrical connectors are used in many electronic systems. It is generally easier and more cost effective to manufacture a system as separate electronic assemblies, which may be joined together with electrical connectors. Connectors may be used for interconnecting assemblies so that the assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted in the printed circuit boards.

In some systems, connections between assemblies may be made through cables. The cables may be terminated with connectors that mate with connectors mounted on a printed circuit board. In this way, connections between assemblies may be made by plugging a connector that is part of cable assembly into a connector that is mounted to printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine, transmission (TCUs), security system, emissions control, lighting, advanced driver assistance system (ADAS), entertainment system, navigation system, and cameras. The ECUs may be manufactured as separate assemblies and connected over one or more vehicle networks formed with cables routed between these assemblies. To simplify manufacture of an automobile, the assemblies may be formed separately and then connected via cables that are terminated with connectors that enable connections to mating connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high-speed signals such as those used to communicate data over an automobile network.

### SUMMARY OF THE INVENTION

Concepts as disclosed herein may be embodied as an electrical connector, comprising (i) a conductive housing comprising a chamber; (ii) a terminal assembly disposed within the chamber, the terminal assembly comprising: (a) a first insulative member; (b) a second insulative member engaged with the first insulative member; and (c) an electrical conductor comprising (1) a mating contact portion, (2) a contact tail, and (3) an intermediate portion joining the mating contact portion and the contact tail, the electrical conductor comprising (a) a first portion held, at least in part, by the first insulative member and (b) a second portion held, at least in part, by the second insulative member.

In another aspect, an electrical connector may comprise: (i) a conductive housing comprising a chamber; (ii) a terminal assembly disposed within the chamber, the terminal assembly comprising: (a) an insulative housing comprising a first insulative member and a second insulative member; and (b) an electrical conductor comprising (1) a mating contact portion extending from the insulative housing in a first direction and (2) a contact tail extending from the insulative housing in a second direction, and (3) an intermediate portion joining the mating contact portion and the contact tail, the electrical conductor comprising (a) a first portion held by the first insulative member and (b) a second portion held between the first insulative member and the second insulative member.

In yet another aspect, an electrical connector may comprise: (i) a conductive housing comprising a chamber; (ii) a shield member within and electrically and mechanically engaged to the conductive housing; (iii) a terminal assembly disposed within the chamber, the terminal assembly comprising: (a) an insulative housing; and (b) an electrical conductor held by the insulative housing; wherein said shield member is configured to provide pressure on the terminal assembly.

In yet another aspect, an electrical connector may comprise: (i) a conductive housing comprising a chamber; (ii) a shield member within and releasably couplable electrically and mechanically to the conductive housing, the releasably couplable shield member separable from the conductive housing; (iii) a terminal assembly disposed within the chamber and releasably couplable to the conductive housing, the releasably couplable terminal assembly separate from the conductive housing, the terminal assembly comprising: (a) a first insulative member; (b) a second insulative member engaged with the first insulative member; and (c) an electrical conductor comprising (1) a mating contact portion, (2) a contact tail, and (3) an intermediate portion joining the mating contact portion and the contact tail, the mating contact portion extending from the first insulative member and the contact tail extending from the second insulative member.

In yet another aspect, an electrical connector may comprise: (i) a conductive housing comprising a chamber; (ii) a terminal assembly disposed within the chamber, the terminal assembly comprising: (a) an insulative housing; and (b) an electrical conductor comprising (1) a mating contact portion extending from the insulative housing and (2) a contact tail extending from the insulative housing, and (3) an intermediate portion joining the mating contact portion and the contact tail; and (4) a hold down comprising (a) a first end engaged with the conductive housing and (b) a second end extending from the second housing, wherein the first end comprises a first compliant arm and a second compliant arm separated by an opening.

### BRIEF DESCRIPTION OF DRAWINGS

The accompanying drawings are not limited to the dimensions shown. For purposes of clarity, not every component may be labeled in every drawing. In the drawings:

FIG. 1 is a perspective view of an illustrative interconnection system, in accordance with some embodiments.

FIG. 2 is an exploded perspective view of the illustrative board connector 100 of FIG. 1.

FIG. 3A is a sectional view of the illustrative board connector 100 of FIG. 1.

FIG. 3B is a rear view of the illustrative board connector of FIG. 3A.

FIG. 4A is a perspective view of an illustrative multiport board connector.

FIG. 4B is a cross sectional view of the illustrative multiport board connector FIG. 4A.

FIG. 5 is a perspective view of cable connector 200 of FIG. 1.

FIG. 6 is an exploded perspective view of the illustrative cable connector of FIG. 5.

FIG. 7 is a sectional view of the illustrative cable connector of FIG. 5.

FIG. 8 is a front, perspective view of an illustrative multiport board connector with a mating interface in a 2×2 configuration mounted to a printed circuit board with press-fit contact tails.

FIG. 9 is a perspective, exploded view of the illustrative press-fit connector of FIG. 8.

FIG. 10A is a perspective view of an illustrative terminal assembly of a press-fit connector at a state of manufacture in which terminals are inserted into a first insulative member.

FIG. 10B is a perspective view of the illustrative terminal assembly of FIG. 10A at a later state of manufacture in which a second insulative member is attached to the first insulative member.

FIG. 10C is a cross-sectional view of the illustrative terminal assembly of FIG. 10B along the line C-C.

FIG. 10D is a side, cross-section view of the illustrative terminal assembly of FIG. 10B along the line D-D.

FIG. 10E is a top view of the illustrative terminal assembly of FIG. 10B.

FIG. 11 is a perspective, exploded view of two terminal assemblies of a press-fit connector.

FIG. 12 is a cross-sectional view of a portion of conductive housing of a press-fit connector illustrating a hold down.

FIG. 13A is a rear view of an illustrative conductive housing of a 2×2 connector showing a shield with retention barbs.

FIG. 13B is an enlarged view of a portion of the shield with the box labeled 13B in FIG. 13A.

FIG. 14A is a perspective view of an illustrative conductive housing of a 2×2 connector, shown in phantom, with a row of terminal assemblies and one shield installed.

FIG. 14B is a perspective view of the illustrative conductive housing of FIG. 14A with two rows of terminal assemblies and two shields installed.

FIG. 15 is an enlarged, side view of a portion of the conductive housing of FIG. 14A showing positioning of a terminal assembly within a conductive housing via a dimple on the shield and a compliant tab.

### DETAILED DESCRIPTION

The inventors have recognized and appreciated techniques for making a connector for providing high data rate transmission that may be economically manufactured yet operate reliably in the harsh environment presented by an automobile. Such a connector would be suitable for interconnecting assemblies in an automotive network, for example. These techniques may be applied in a modular connector system in which a set of components may be combined to form connectors in any of multiple configurations. The cost associated with manufacturing connectors of the types described herein may be reduced by designing the parts of the connectors to be modular.

Each connector configuration may be formed from an insulative outer housing that establishes at least a mating interface of the connector. The insulative outer housing may provide latching features. The set of components may include insulative outer housings in complementary configurations, which may be used to form two connector configurations that will mate and latch to each other.

A conductive structure at least partially encircling a cavity may be positioned within the outer housing. The cavity may be open at a mating end extending into the mating interface. The set of components may include conductive structures in one or more configurations that mate to each other. A conductive structure, for example, may be die cast with a cavity or may be one or more sheets of metal formed into a tube. A tube, forming one conductive structure of the set, may be sized to fit within an opening into a cavity of another conductive structure such that the conductive structures can mate. Alternatively, the set may include tubes of one radius sized to fit within a tube of a larger radius. In some embodiments, multiple conductive structures may be incorporated into the same insulative outer housing to configure connectors of different sizes. Alternatively or additionally, die cast conductive structures may be formed with different numbers of cavities.

Regardless of the number of cavities integrated within the housing, a terminal assembly may be inserted into the cavity. Each terminal assembly may have an insulative member that receives one or more electrical conductors, each of which may serve as a terminal of the connector. The set of connector components may include at least two styles of terminals configured to mate to one another, such as pin and receptacle style terminals. Terminals may also have different style tails, with tails configured for attachment to a printed circuit board or to attach to a conductor of a cable.

The different mating and mounting configurations may be used in combination to form board connectors or cable connectors with mating interfaces that allow intermating of the connectors. A board connector may mate with a cable connector, or two cable connectors may mate, for example. Further, a board connector may be configured for different mounting techniques by using different terminal assemblies. A terminal assembly, for example, may be configured for pin in paste or through hole soldering to the PCB. A terminal assembly of a different configuration may be used to configure a board connector for press-fit mounting.

Modularity among the components of the electrical connector may be provided, for example, with a conductive housing comprising a chamber, a shield member within and releasably couplable electrically and mechanically to the conductive housing such that the shield member is separable from the conductive housing. A terminal assembly disposed within the chamber may be releasably couplable to the conductive housing such that the terminal assembly is separable from the conductive housing. With this arrangement, a connector may be assembled in any of multiple configurations by inserting a different terminal assembly, which may then be locked in place through insertion of a shield. The terminal assembly, for example, may include a first insulative member, a second insulative member engaged with the first insulative member, and an electrical conductor comprising a mating contact portion, a contact tail, and an intermediate portion joining the mating contact portion and the contact tail, the mating contact portion extending from the first insulative member and the contact tail extending from the second insulative member. The first and second insulative members may be engaged to each other with each insulative member holding a different portion of the conductor. Such a terminal assembly may be used with a press-fit board connector. A terminal assembly with a single insulative member holding conductors may be used for other mounting configurations.

Optionally, each terminal assembly may be configured to carry one signal, whether as a single ended signal or as a differential signal. In the exemplary embodiments illustrated below, each terminal carrier has a pair of electrical conductors suitable for carrying a differential signal. The conductive structure bounding the cavity into which the terminal carrier is inserted may serve as a shield for the differential signal. The mating interfaces may be such that the terminals of mating connectors mate, both mechanically and electrically, as do the conductive structures forming shields around those terminals.

The inventors have recognized and appreciated various techniques that may be applied to the components of the connector system to provide connections with high signal integrity (SI). The SI improvements may result from controlling the electrical properties of the signal paths through the connector and/or from configuring the connector to operate effectively, notwithstanding the rugged automotive environment in which the connector is used.

For example, techniques as described herein may enable a terminal assembly for press-fit mounting to be easily assembled, but to provide sufficient mechanical integrity to ensure that the relative position of the electrical conductors of the terminal assembly and ground structures within the connector are precisely controlled even after the connector has undergone the stresses of press-fit mounting and use. Through use of these techniques, the electrical conductors may provide a uniform and stable impedance through the connector, which may enable high speed operation, even in a rugged environment.

One such technique may provide for mechanical and/or electrical stability of electrical conductors within a terminal assembly by holding the conductors within first and second insulative members. The terminal assembly may be positioned within a chamber formed by a conductive housing, which may serve as a ground around the conductors. The first and second insulative members may be engaged to each other with each insulative member holding a different portion of the conductor. The first and second insulative members may be configured to provide stable positioning of the conductors with respect to the conductive housing despite the forces on the conductors during press-fit mounting of the connector and use of the connector in a harsh environment with substantial vibration.

Another technique providing for additional mechanical and/or electrical stability of the electrical connector includes a conductive housing with a chamber, a shield member within and electrically and mechanically engaged to the conductive housing, a terminal assembly disposed within the chamber. The shield member may be configured to provide pressure on the terminal assembly, forcing it into a position determined by the structure of the conductive housing. The shield member may include a dimple that engages with an insulative housing in the terminal assembly for applying pressure on the terminal assembly. The shield may further include compliant tabs that fit within grooves in the conductive housing and bias the shield towards the terminal assembly.

Another technique that may provide for additional mechanical and/or electrical stability of the electrical connector includes a shelf with a hole in the conductive housing adjacent to a mounting interface with a hold down that extends through the hole in the shelf to retain the electrical connector to a printed circuit board (PCB). The hold down may include a first end extending through a first surface of the shelf, and one or more barbs engaging the first surface of the shelf.

Another technique providing for additional mechanical and/or electrical stability of an electrical connector configured for use as a board connector may relate to a hold down for holding the connector against a PCB to which it is mounted. The hold down may be configured for easy insertion, yet to provide strong retention force with little play between the hold down and the connector housing. The hold down, for example, may engage the conductive housing of the connector, which may be formed of metal, such as via diecasting, such that the housing is mechanically stable. An end of the hold down that is inserted into an opening of the conductive housing may be designed with compliance such that the hold down may be compressed as it is inserted through a hole through a shelf of the conductive. The compliant portions of the hold down may include barbs that engage an upper surface of the shelf. The barbs may be compressed towards the center of the hold down for insertion through the hole and may spring outwards to engage the shelf once pushed through the hole. Such a connector may include a conductive housing comprising a chamber, a terminal assembly disposed within the chamber, the terminal assembly comprising an insulative housing; and an electrical conductor comprising a mating contact portion extending from the insulative housing and a contact tail extending from the insulative housing, and an intermediate portion joining the mating contact portion and the contact tail, and a hold down comprising a first end engaged with the conductive housing and a second end extending from the insulative second housing, wherein the first end comprises a first compliant arm and a second compliant arm separated by an opening.

These techniques may be used singly or in combination. These techniques are illustrated below in connection with an interconnection system that may be used, for example, to make physical connections between assemblies in an automobile.

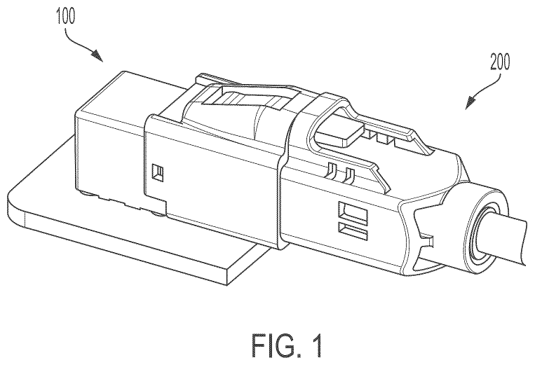

FIG. 1 is a perspective view of an illustrative interconnection system, in accordance with some embodiments. The interconnection system may be used to connect two electronic devices to one another. In some embodiments, interconnection system is used in high data rate transmission applications (e.g., in applications including ECUs of automotive vehicles). In this example, the interconnection system comprises a board connector 100 and a cable connector 200.

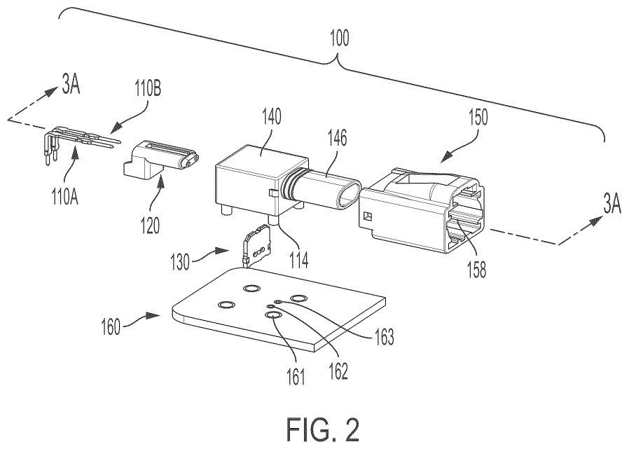

FIG. 2 is an exploded perspective view of the illustrative board connector 100 of FIG. 1 when not mated to cable connector 200, in accordance with some embodiments. Board connector 100 includes an opening 158 of the housing 150, which may be arranged to allow passage of mating contacts therethrough. The mating interface of board connector 100 may be disposed within opening 158.

Board connector 100 also includes a conductive housing 140. Conductive housing 140 may be a die cast component, for example. In this example, conductive housing has a mating portion 146 that extends into opening 158 when insulative housing 150 is attached to conductive housing 140.

Conductive housing 140 may include a chamber into which a terminal assembly is inserted. In this example, a terminal assembly may be formed by insulator 120 and one or more electrical conductors held by insulator 120. As shown, board connector 100 includes electrical conductors that may serve as signal conductors. In this example, a pair of electrical conductors is shown such that the illustrated terminal assembly is configured for passing a differential signal. In addition to transmitting one or more signals through the connector, the electrical conductors may have a mating contact portion at one end, a tail at the opposite end and an intermediate portion therebetween. Accordingly, the electrical conductors may serve as contacts for the connector.

In the example of FIG. 2, the mating contact portions of the electrical conductors are shaped as pins such that board connector 100 is configured as a header. In other embodiments, the mating contact portions of the electrical conductors in a header connector may be shaped as blades or have other shapes. Alternatively or additionally, in some embodiments, a board connector may have electrical conductors with mating contact portions shaped as receptacles. In the example of FIG. 2, the tails of the electrical conductors are shaped as posts. Posts, for example, may be mounted to a printed circuit board using plated through hole or pin in paste soldering techniques.

FIG. 2 illustrates a plurality of mating contacts, including contacts 110A and 110B (also referred to herein as “terminals”). The mating contact portions of the terminals extend into opening 158. Tails of contacts 110A and 110B extend from a mounting interface of board connector 100 for mounting to a printed circuit board 160. Contacts 110A and 110B may be electrically connected to holes 162 and 163 on a board 160. In some examples, the board 160 may be a printed circuit board (PCB).

Opening 158 may be shaped and sized to receive a mating connector therein. The mating connector may include mating contacts configured to electrically connect to contacts 110A and 110B when the interconnection system is in the mated configuration.

One or more mating contacts may be held within insulator 120 to form a terminal assembly. The insulator may be shaped and sized to receive the mating contacts. For example, the contacts 110A and 110B may pass through openings of insulator 120. The insulator 120 can be inserted into a cavity within conductive housing 140. In this way, conductive housing will partially encircle the terminal assembly, and the electrical conductors in the terminal assembly.

Conductive housing 140 may further include attachment posts, configured to electrically and mechanically connect conductive housing 140 to the board 160. For example, the attachment posts may extend into holes 161, which may be ground vias. By grounding conductive housing 140, it may serve as a shield for the terminal assembly, and the pair of conductors in the terminal assembly.

The board connector 100 may include one or more additional shield members, here illustrated as shield 130. Shield 130 is also inserted into the cavity of conductive housing 140, to further encircle the terminal assembly. Shield 130 is electrically and mechanically coupled to conductive housing 140 such that shield 130 may also be grounded. Shield 130, in conjunction with a spacer on insulator 120, may also serve to position the terminal assembly within the cavity and, in so doing, may establish signal to ground spacing for the electrical conductors within the terminal assembly. Such a configuration may provide a desired and stable impedance.

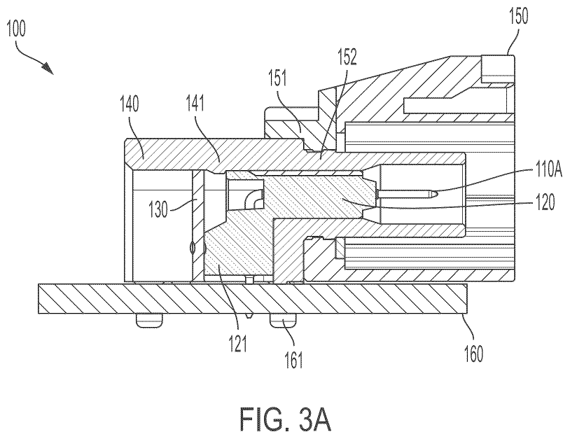

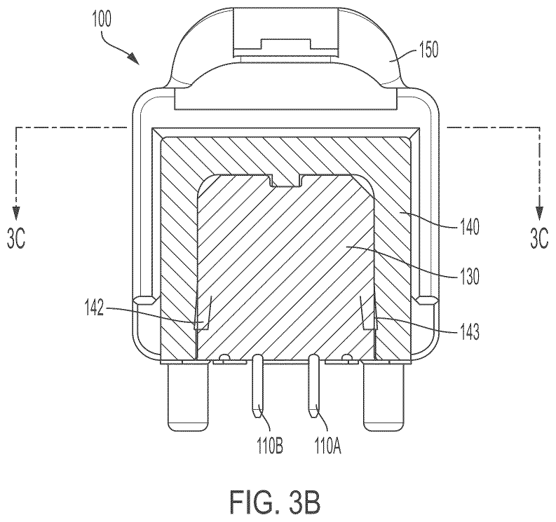

FIG. 3A is a sectional view of the illustrative board connector 100 of FIGS. 1 and 2, taken along the line 3A-3A in FIG. 2. As described herein, the board connector 100 includes insulator 120. The insulator may include a rib 121. The rib 121 may serve as a spacer, positioning the terminal assembly with respect to shield 130. The spacer may be sized and arranged to establish a designed separation between shield 130 and terminals 110A and 110B. The appropriate size and shape of the spacer may be determined based on a desired impedance. Shield 130 may contact one side of the rib 121.

As described herein, the insulator 120 and shield 130 may be engaged in conductive housing 140. Conductive housing 140 may include a retention feature 141 for preventing movement and absorbing force of the insulator 120. The retention feature 141 may be a rib configured to contact a wall of the insulator 120. Conductive housing 140 may further include a recess 152. The housing 150 may include a retention feature 151, which is configured to engage with the respective recess 152 of conductive housing 140.

FIG. 3B is a rear view of the board connector 100 of FIG. 3A, in accordance with some embodiments. The conductive housing 140 may also include retention features 142 and 143 for retaining shield 130.

Each of the contacts 110A and 110B may include one or more retention features configured to prevent movement of the contact in the insulator 120 of the connector 100. For example, the contact 110A includes a barb, configured to provide retention of the contact within the insulator. For example, insulator 120 may include a channel receiving each of the contacts 110A and 110B. The barb digs into the insulator at the side of the channel to firmly retain the contact. The channels are narrower proximate the barb and wider away from the barb.

In some embodiments, the barb and/or the width of the channel may appreciably impact impedance along contact 110A or 110B. Accordingly, the contact may be provided with an impedance compensation section proximate the retention feature. In this example, the impedance compensation section is formed by a narrowing portion.

In the illustrated embodiment, contacts 110A or 110B have the same shape. Accordingly, they may have the same retention features and same impedance compensation sections. It should also be appreciated that there may be more than one retention feature along the length of a contact 110A. Each retention feature, and the impedance compensating sections proximate the retention feature, may be similarly shaped. However, in some embodiments, the retention features along the length of a contact may have different sizes or different shapes.

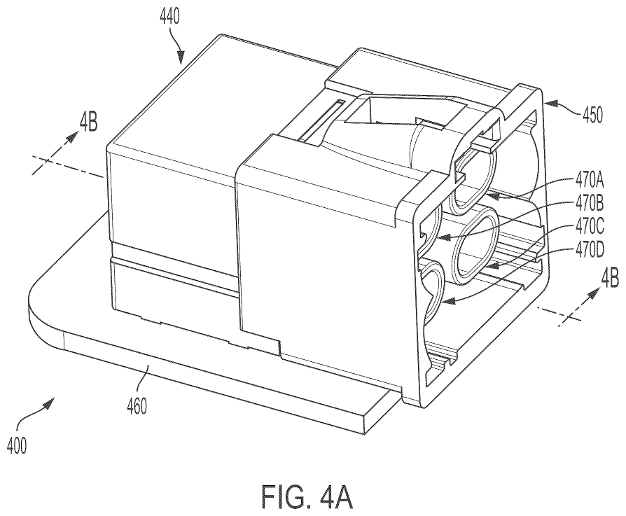

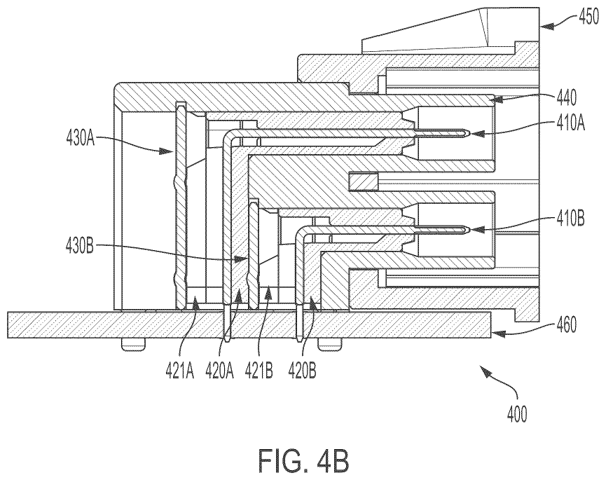

FIG. 4A is a perspective view of an illustrative multiport board connector 400, in accordance with some embodiments. For example, FIG. 4A shows a 2 by 2 connector 400 including 4 ports arranged in two rows of two ports. The conductive housing is shown with ports 470A-D, each of which is shaped and sized to receive a mating element therein. Each of the ports may have the same configuration as the mating portion 146 of board connector 100, such that the same mating elements may mate with either connector. As with board connector 100, conductive housing 440 is configured to be mounted to a board 460. An insulative housing 450, providing the same functionality as insulative housing 150 for a larger connector is attached to conductive housing 440.

FIG. 4B illustrates a portion of the cross-sectional view along the line 4B-4B of FIG. 4A, in accordance with some embodiments. In the example of FIG. 4B, contacts in two of the ports are visible. As with connector 100, connector 400 has a pair of contacts in each port. In this example, the contacts in each port are held in a separate insulator, forming a terminal assembly for each of the ports. The insulators may have the same functions as described above for connector 100. For example, mating contact 410A is disposed in insulator 420A comprising a rib 421A. Mating contact 410B is disposed in insulator 420B comprising a rib 421B. Ribs 421A and 421B each positions its respective terminal assemble relative to a respective shield 430A and 430B. Each of the shields and insulators are engaged in the conductive housing 440, which is further disposed in an insulative housing 450.

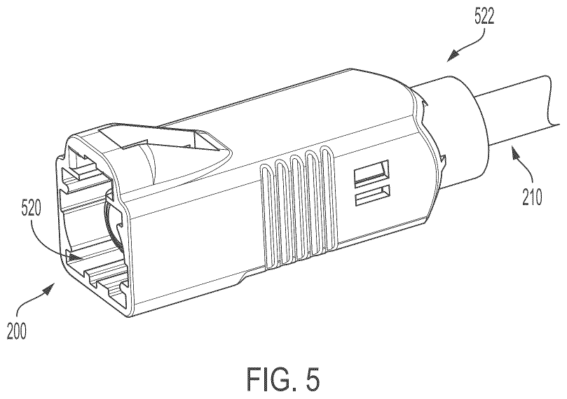

FIG. 5 is a perspective view of cable connector 200, in accordance with some embodiments. Cable connector 200 may have components analogous to those described above for board connector 100, including an outer insulative housing, an inner conductive housing that acts as a shield and a terminal assembly inside a cavity within the shield. The outer insulative housing, however, may have a mating interface and latching features that are complementary to those on board connector 100 such that cable connector 200 may mate with board connector 100. Likewise, inner conductive housing may have a mating portion configured for mating with mating portion 146. Further, the terminal assembly, as well as other components, may be configured for terminating a cable rather than mounting on a printed circuit board. For example, the contacts may be electrically coupled to one or more conductors of a cable.

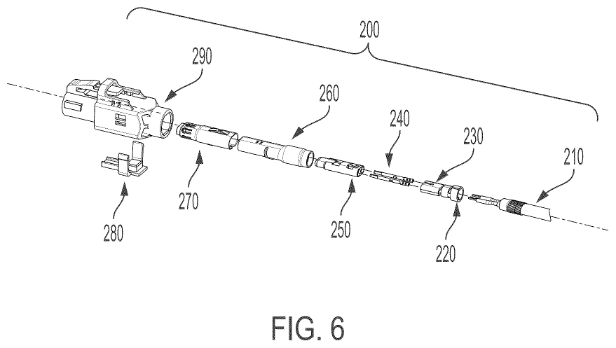

FIG. 6 is an exploded perspective view of an illustrative cable connector 200, in accordance with some embodiments. As illustrated in FIGS. 5 and 6, the illustrative cable connector 200 is configured to terminate cable 210. Cable connector 200 comprises a mating end 520 and a cable termination end 522 opposite the mating end. A cavity is open at the mating end 520. The connector terminates a cable at the cable termination end 522, where the cable has been manipulated to facilitate termination.

The bulk of the cable 210 may comprise one or more insulated conductors. In the example provided, the cable contains a pair of insulated conductors surrounded by a cable shield, which is then covered by an insulative jacket. The cable shield, for example, may be a braided shield or a conductive foil. For termination, the jacket may be removed, exposing the cable shield. The insulated conductors may be separated and at the distal ends, the insulator may be removed. For cables in which the insulated conductors are twisted together in the bulk cable, separating the insulated conductors may also involve untwisting the conductors. This manipulation of the cable enables the conductors of the insulated conductors to be attached to terminals of a connector. The cable shield may also be attached to a connector shield.

The cable connector 200 further includes ferrule 220 and impedance adapter 230 which may be disposed around the cable 210. According to some embodiments, the impedance adaptor may be metal. The terminals 240 may be crimped to the conductors of the cable. The terminals may be a portion of a terminal assembly with an insulator, here illustrated as a contact carrier housing 250. The conductive inner housing of the cable connector may be formed from back and front shields 260 and 270, which may be electrically and mechanically coupled. The front shield 270 may include a mating interface and the rear shield 260 may be crimped to the cable and may be electrically coupled to the cable shield. These components may be at least partially enclosed in a cable connector housing 290.

The components 220, 230, 240, 250, 260 and 270 illustrated in FIG. 6 terminating the cable provide a contact carrier. In this example, the contact carrier is shielded. The position of the contact carrier within the housing may be secured using a contact carrier position assurance device (CCPA) 280.

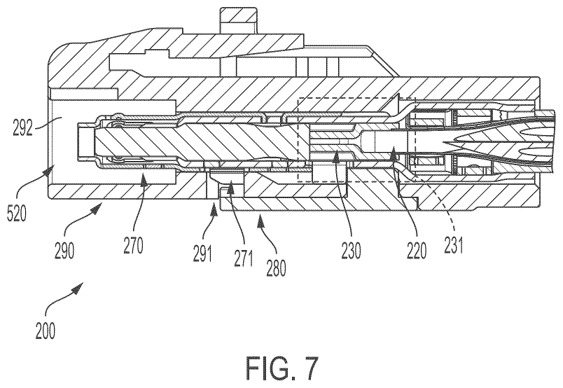

FIG. 7 is a sectional view of the illustrative cable connector of FIG. 6, in accordance with some embodiments. The impedance adapter 230 is in the separated and/or untwisted area 231 of the cable termination. The area 231, where the cable has been manipulated, provides space to perform the crimping process of the contacts to the conductors of the cable. However, this manipulation of the cable modifies the impedance of the conductors. The metal is provided in proximity to the cable in order to provide a compensating change of impedance in the opposite direction. The impendence adaptor brings metal closer to the cable core. In the illustrated embodiments, the impedance adaptor will also be in contact with the back shield which connects the impedance adaptor to ground, establishing the signal to ground spacing for the conductors of the cable, which in turn establishes a desired impedance to match the impedance of the bulk cable. As used herein, impedances need not be identical to be matched. Rather, the impedances may be sufficiently close so as not to provide an impedance discontinuity that disrupts performance. For example, matched impedances may be within +/−5% or within +/−3 Ohms, in some embodiments.

To terminate cable 210, the cable end may be prepared for termination and inserted through ferrule 220 and impedance adapter 230. The cable shield may be folded over ferrule 220 and the conductors of cable 210 may be crimped to terminals 240. Terminals 240 may then be inserted into contact carrier housing 250. Back shield 260 may then be crimped around ferrule 220. Front shield 270 may then be engaged to back shield 260 and latched in place. These components may form a terminated cable assembly that is inserted into housing 290. The housing 290 may include an opening 292 to receive the terminated cable assembly.

The terminated cable assembly may be latched to housing 290, such as by latching a beam in the housing to a tab extending form one of the connectors shields. The housing 290, for example, may include a beam 294 comprising a cantilevered end 291 and a latch 293 at the cantilevered end 291 that extends into the opening 292. The latch 293 may have camming surface 295 and the tab of the terminated cable assembly may have a forward edge that is tapered. As the terminated cable assembly is inserted into housing 290, the tapered surface of the tab may engage the camming surface of latch 293, forcing latch 293 upwards, until the rear edge of the tab clears the camming surface. In that position, the spring force in deflected beam 294 will push the beam downwards, latching the tab in place.

FIG. 7 illustrates a connector with one contact carrier held in an insulative housing. Such a connector may be configured to mate with a single port board connector, such as is illustrated in FIG. 1. A plug connector may be constructed to mate with a multiport connector, such as is illustrated in FIG. 4A, by incorporating multiple contact carriers within an insulative housing.

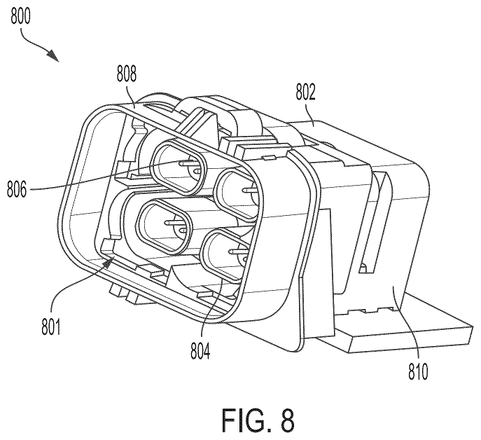

FIG. 8 is a perspective view of an illustrative multiport board connector 800. In this example, connector 800 has a mating interface 801 with 2 rows of 2 ports each, providing a 2×2 connector. Connector 800 may be constructed using some or all the techniques described above in connection with board connectors 100 or 400. Connector 800, for example, may include a conductive housing 802 having mating portions 804, conductors 806 within terminal assemblies, and a front housing 808. The connector is shown attached to the printed circuit board 810. The conductive housing 802 may be a die cast component with a cavity with openings to receive multiple terminal assemblies. In contrast to connector 400 (FIG. 4A), some or all of the components of connector 800 may be configured for press fit attachment to a printed circuit board.

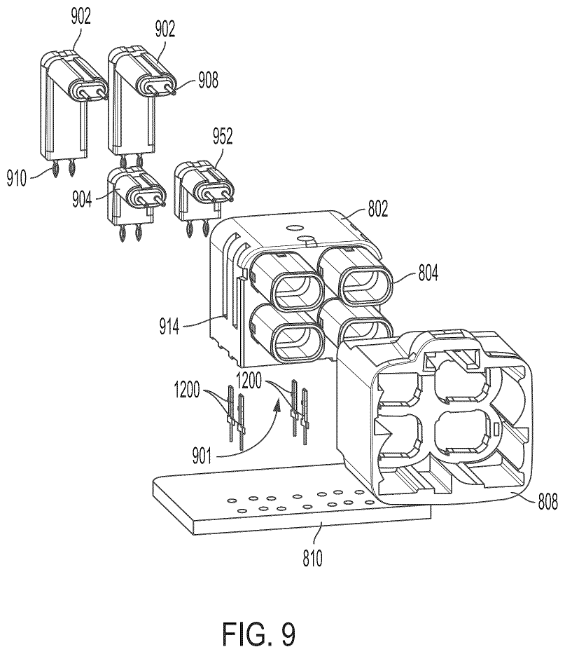

FIG. 9 is a perspective, exploded view of connector 800. In this view, the tails of the electrical conductors are visible and are press-fits, in contrast to the tails shaped as posts, as described above. Other components of connector may be adapted to provide electrically and mechanically stable and reliable connections between components, both during mounting of the connector to a PCB and during use. The insulative housing of the terminal assemblies, for example, may be different than described above. The terminal subassemblies may be adapted to withstand the force exerted on the terminal assemblies during mounting or to withstand vibration during use. Other board attachment features may be used. For example, FIG. 9 illustrates that connector 800 has hold downs 1200 rather than attachment posts, such as posts 114 shown in FIG. 2.

The connector includes a conductive housing 802 having a mating portion 804. Connector 800 includes a front housing 808 over the mating portion 804, and terminal assemblies 902 and 952 inside the conductive housing 802. In this example, terminal assemblies 902 are taller and are configured for forming the top row of the mating interface. In contrast, terminal subassemblies 952 are shorter and are configured for forming the bottom row of the mating interface. Each of the terminal assemblies 902 includes conductors 806 having tail portions 906, and mating contacts 908. Each of the terminal assemblies 902 further includes insulators 904. The conductors 806 may be positioned within insulators 904 with the mating contacts and tail portions exposed at two opposing ends of the conductor. The connector may further include hold downs 1200 attaching the conductive housing 802 to the printed circuit board 810. Each of the terminal assemblies 902 may be disposed within a chamber in the conductive housing 802. Terminal subassemblies 952 similarly hold conductors within conductive housing 802, but the dimensions differ with respect to termina subassemblies 902.

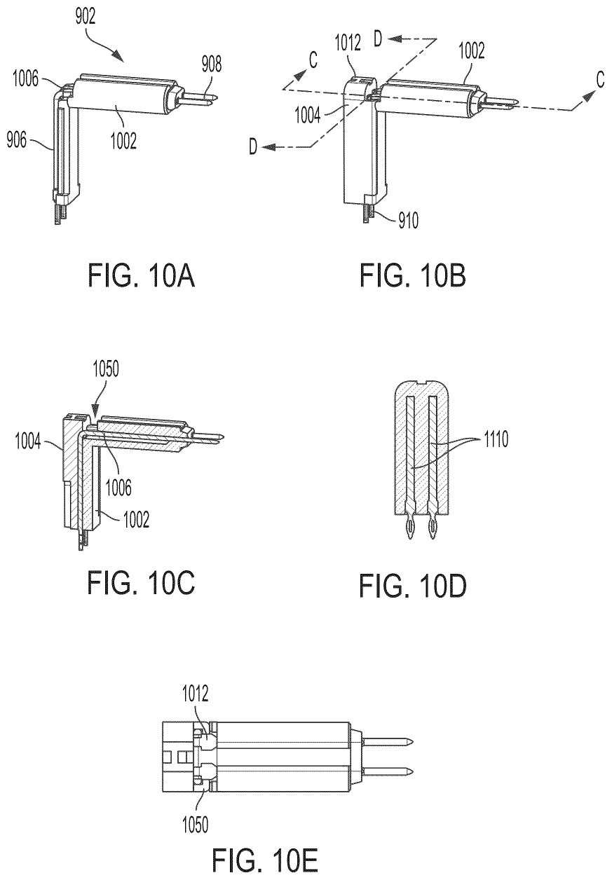

FIG. 10A is a perspective view of a terminal assembly 902 of a press-fit connector. Terminal assembly 902 may be representative of any of the terminal assemblies 902 or 952, which may differ in horizontal and/or vertical dimensions to position the mating contacts and the tail portions of the conductors in the desired locations. In this example, the terminal assembly 902 is illustrated with dimensions for use in an upper row of the 2×2 mating interface. Terminal assemblies used in a lower row may have similar construction, with shorter horizontal and vertical dimensions. Conversely, a terminal assembly used in a higher row in a connector with more rows in the mating interface, may also use similar construction techniques, with longer horizonal and vertical dimensions.

In this example, terminal assembly 902 may be constructed to enable easy assembly of the conductors with the insulative housing of the terminal assembly, even in a right angle configuration in which the terminal assembly is configured to hold the mating contacts and tail portions for integration into a mating interface and mounting interface 901, respectively, that are at right angles to each other. As illustrated, the insulative housing may include two or more pieces that engage one another and can hold one or more conductors (e.g., two conductors) in stable relationship relative to each other and the conductive housing around the terminal assembly.

The terminal assembly 902 may include a first insulative member 1002 and a second insulative member 1004. The first insulative member 1002 may be engaged with the second insulative member 1004. The terminal assembly 902 may include conductors 806, each conductor 806 having a tail portion 906, a mating contact portion 908, and an intermediate portion 1006. In this example, the mating contact portions 908 are shaped as pins. The intermediate portion 1006 may join the mating contact portion 908 and the tail portion 906 of the conductor 806. Optionally, the first insulative member 1002 may hold, at least in part, one portion of the conductor 806 while the second insulative member 1004 may hold, at least in part, another portion of the conductor 806. These two parts may extend in transverse directions. In the illustrated example, they extend in orthogonal (e.g., perpendicular) directions. FIG. 10A illustrates a first portion 1102 of the conductors inserted through holes through a first region of the first portion of the insulator. A second portion 1104 of the conductors are partially supported by a second region of the first portion of the insulator.

In the example of FIG. 10A, the second portion 1104 of the conductor is held between the first portion and the second portion of the insulative housing. Such a configuration enables the conductors to be inserted into the first portion and then the second portion of the insulative housing may be engaged to the first portion and slid into position, capturing the second portion of the conductors between the first and second portions of the insulative housing, providing support for the conductors, even as force is exerted on the conductors when the connector is pressed onto a printed circuit board.

FIG. 10B is a perspective view of the terminal assembly 902 with a second insulative portion 1004 engaged with the first insulative portion 1002. FIG. 10C is a cross-sectional view of the terminal assembly 902 through the line C-C of FIG. 10B. In this view, the portion of a conductor extending through an opening in the first insulative member is visible, as is the portion of the conductor captured between the first insulative member and the second insulative member.

Optionally, the second insulative member may be rounded at the top to conform with the shape of openings in the conductive housing into which the terminal assembly is inserted.

The conductors 806 may have press fit tails. FIG. 10D is a cross-section view of the terminal assembly 902 taken along the line D-D of FIG. 10B. In this view, portions of a pair of conductors 806 disposed within a channel 1110 of the second insulative member are visible. As can be seen, the channel is closed at the top, giving the surface of the second insulative member facing the first insulative member a T-shaped configuration. The second insulative member serves as a sleeve to support the conductors 806. Lateral motion of the portions of the conductors captured between the first insulative member and the second insulative member is prevented. Further, once the terminal assembly is inserted into a chamber within the conductive housing, the upper portion of the second insulative member 1004 will be prevented from moving upwards by an upper wall of the chamber. Upwards motion of the conductors 806 will be blocked by the closed upper end of the second insulative member 1004.

The second insulative member 1004 may be positioned as shown by engaging the second insulative member 1004 to the first insulative member 1002 after the conductors 806 have been inserted into the first insulative member 1002. In this example, once the second insulative member 1004 is engaged to the first insulative member 1002, it is then slid into position. Optionally, each of the press fit pins 910 has a shoulder 1012. The second insulative member 1004 may engage the shoulder area 1012 of the press fit pins 910, further preventing upward movement of the conductors when the tail end is pressed into a printed circuit board.

FIG. 10E is a top view of the terminal assembly 902 of FIG. 10B. Visible in this view is a gap 1050 between the first insulative member and the second insulative member. The gap 1050 may equalize impedance along the length of conductors 806 by introducing material of lower dielectric constant adjacent select portions of the conductor 806. The gap 1050, for example, may be adjacent to wider portions with barbs or other features that engage either or both of the insulative members of the terminal assembly housing. In some embodiments, the terminal subassemblies may be configured for a specific impedance, such as 100 Ohms for a differential pair. Instead of or in addition to one or more gaps, such as gap 1050, the first and/or second insulative members may be molded of insulative materials with low dielectric constant, such as in the range of 2.5 or less.

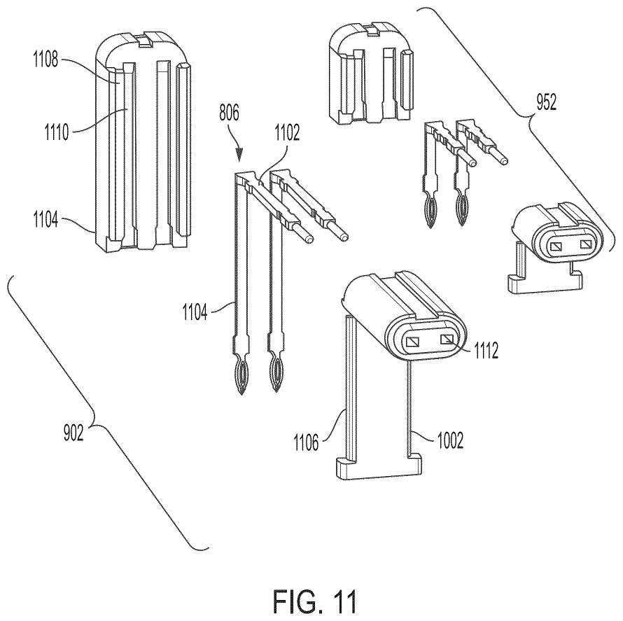

FIG. 11 shows perspective, exploded views of a terminal assembly 902 and a terminal assembly 952 with press fit conductors. These may be two of the terminal assemblies within a 2×2 connector, such as is shown in FIG. 8. Terminal assembly 902 is longer and terminal assembly 952 is shorter. Each of the two terminal assemblies may include an electrical conductor 806 having a first portion 1102 and a second portion 1104. Each of the two terminal assemblies may also include a first insulative member 1002 and a second insulative member 1004. The first insulative member 1002 may be engaged to the second insulative member 1004 via a first interlocking feature 1106 on the first insulative member 1002 and a second interlocking feature 1108 on the second insulative member 1004. The second insulative member 1004 may have a channel 1110 to receive the second portion 1104 of the electrical conductor 806. The first insulative member 1002 may also have channels (not shown) to receive the first portion 1102 and second portion 1104 of the electrical conductor 806. The second portion 1104 of the electrical conductor may be parallel to the contact tail of the electrical conductor. The contact tail of the electrical conductor may be disposed at the mounting interface. The contact tail may be a press fit tail. The first insulative member 1002 may have openings or holes 1112 through which the mating contacts 908 of the electrical conductor 806 may be placed.

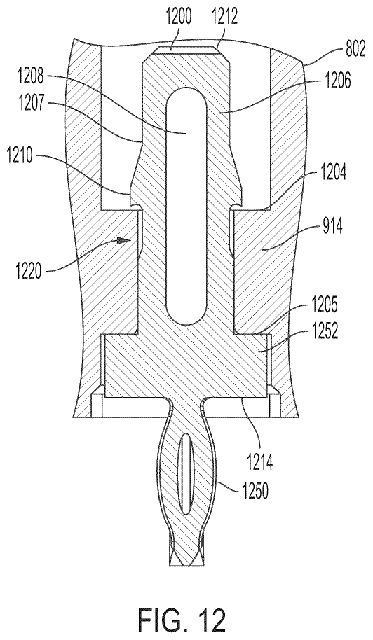

FIG. 12 is a cross-sectional side view illustrating a hold down 1200 that may be used with a press-fit connector, such as connector 800. The hold down 1200 extends through a hole 1220 in a shelf 914 of the conductive housing 802. The hold down 1200 is configured to retain the electrical connector to a printed circuit board (PCB). The shelf 914 of the conductive housing 802 may have a first surface 1204 and a second surface 1205. The hold down 1200 may be blocked in the downward direction by the first surface 1204 of the shelf 914 of the conductive housing 802. The hold down 1200 may be blocked in the upward direction by the second surface 1205 of the shelf 914 of the conductive housing 802. Accordingly, when press fit 1250 extending beyond the conductive housing at the lower end of hold down 1200 is inserted into a hole in a printed circuit board, conductive housing 802 may be held firmly against the surface of that printed circuit board.

Hold down 1200 may be stamped from a sheet of metal. When attached to conductive housing 802, it may include a first end 1212 extending through the first surface 1204 of the shelf 914 of the conductive housing 802 and one or more barbs 1210 engaging the first surface 1204 of the shelf 914 of the conductive housing 802. Hold down 1200 may also include one or more shoulder portions 1252, which abut second surface 1205. The hold down 1200 may include a second end 1214, opposite the first end 1214, with a press fit 1250 configured to be press-fit into a hole of the printed circuit board.

To facilitate insertion of the first end 1212 through hole 1220, hold down 1200 may include a first compliant arm 1206 and a second compliant arm 1207 separated by an opening 1208 through the hold down 1200. The hold down 1200 may be compressed for insertion through the hole 1220 in the shelf by deflection of the first arm 1206 and/or the second arm 1207 towards the opening 1208. The hold down configuration with compliant arms that may be deflected for insertion of the hold down into a conductive housing, which may be made of die cast metal enables barbs 1210 to engage surface 1204 over a relatively large area, providing stable retention of the connector.

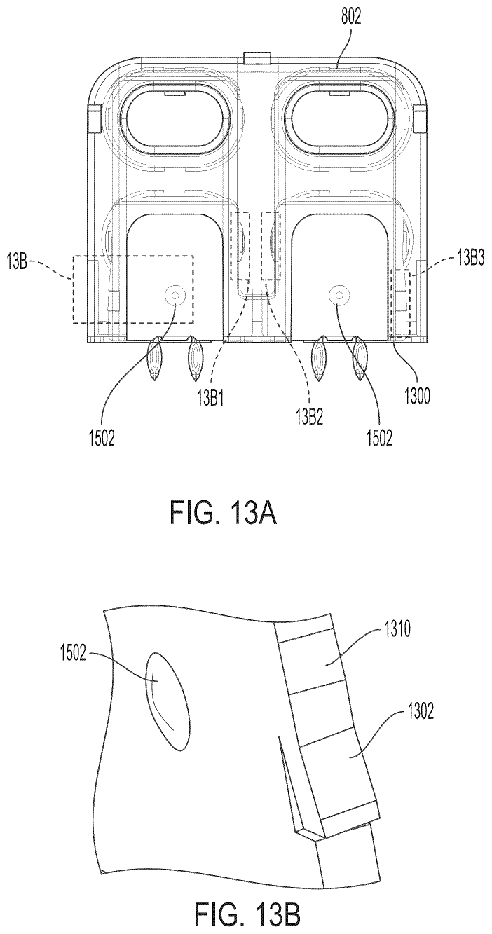

FIG. 13A is a rear view of an illustrative conductive housing 802 of a 2×2 connector showing a shield 1300. Once terminal assemblies are inserted into the cavity of the conductive housing, one or more shields may be inserted into the cavity. Each shield may close an opening through which one or more terminals were inserted. The shield, in combination with the conductive housing, provides shielding around the terminal assemblies. The shield 1300 may lie within and be electrically and mechanically engaged to the conductive housing 802. The shielding may additionally mechanically retain one or more terminal assemblies within the cavity of the conductive housing. In the example of FIG, 13A, shield 1300 is installed after two shorter terminal assemblies 952 have been inserted. In other examples, the two shields, each corresponding to one terminal assembly may be inserted.

Shields may include one or more features that enhance the electrical and/or mechanical connection between the shield and the conductive housing. Such features may enhance signal integrity of the connector by urging the terminal assembly into a desired position with respect to a grounding structure around it, whether that grounding structure is the conductive housing 802 or the shield itself, and/or preventing relative motion of the terminal assembly and the grounding structure.

One such feature on the shield may be a tab cut from the shield that is bent to act as a barb, engaging the conductive housing. The shield, for example, may be stamped from a sheet of stales steel or other metal that similarly has spring properties. Accordingly, a tab cut from the shield and bent out of the plane of the shield to engage a corresponding feature of the conductive housing may bias the shield plate in predetermined direction.

FIG. 13B is an enlarged view of a portion of the shield 1300 shown within box 13B of FIG. 13A. In this example, portion 13B includes an edge 1310 of shield 1300. As can be seen in FIG. 13B, a tab 1302 may be cut out of the body of the shield at or adjacent the edge. In this example, tab 1302 is bent in a rearward direction. When the edge of the shield is in inserted into a groove in conductive housing 802, tab 1302 may be compressed back towards the plane of the body of shield 1300, generating a spring force against an interior surface of the groove. In this example, tab 1302 is bent in a rearward direction, urging shield 1300 in a forward direction. In this way, the shield will urge the terminal assembly into a rearward facing surface at the front portion of the conductive housing. The position of a terminal assembly 952 may be stably established with respect to the forward, interior surface of the conductive housing and shield 130 may be close to and precisely positioned with respect to the rearward surface of the terminal assembly. Shield 1300 may have one or more other such retention features. For example, a similar tab, also acting as a barb engaging a groove within the conductive housing 802, may be formed in each of regions 13B1, 13B2, and 13B3.

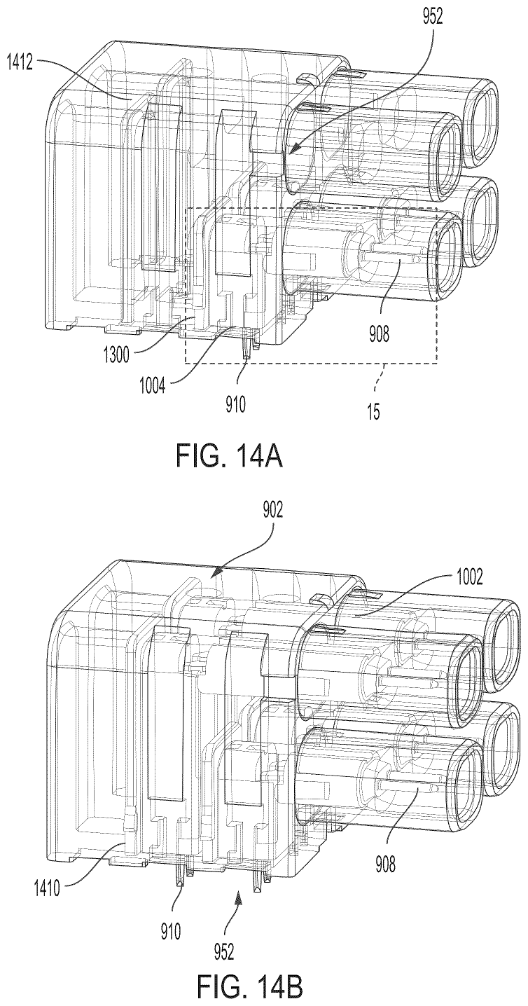

FIG. 14A is a perspective view of two short terminal assemblies 952 held in position by shield 1300. In this figure, the conductive housing 802 is shown in phantom.

FIG. 14B shows the connector of FIG. 14A, at a later stage of manufacture in which two long terminal subassemblies 902 are inserted into conductive housing 802 and held in place with a shield 1410. Shield 1410 may have features as described in connection with shield 1300, but may be taller so as to cover substantially all of a rear surface of taller subassemblies 902. Shield 1410 may likewise be inserted into a groove, such as groove 1412 (FIG. 14A) and may similarly include features along one or more of the edges inserted within such a groove, which may be as illustrated above in connection with FIG. 13B.

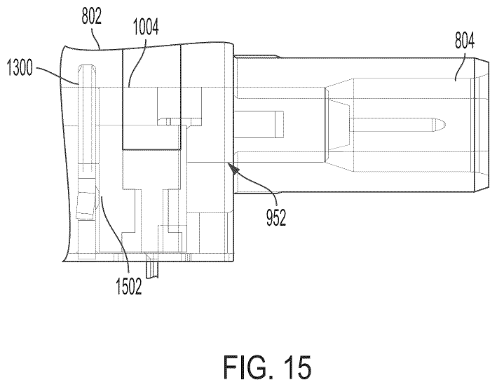

As another example of a feature that may be incorporated on a shield for precisely and stably positioning terminal subassemblies with respect to grounding structures, a shield may include a dimple 1502. FIG. 15 is a side view of a portion 15 of a press-fit connector of FIG. 14A or 14B showing a dimple 1502 on the shield 1300. Dimple 1502 may be formed as a protrusion embossed in the body of the shield. The dimple 1502 may press on the rearward surface of the insulative member of the terminal assembly, which in this example is the rearward surface of second insulative member 1004. Dimple 1502 of the shield 1300 may provide a force on the terminal assembly to urge it towards the mating portion 804 of the conductive housing 802 when shield 1300 is inserted. Such a configuration will precisely and stably position the terminal assembly 952 with respect to the conductive housing 802. Dimple 1502 may yield however, if, because of tolerances in the manufacture of one or more components, the body of shield 1300 were closer to terminal assembly 952 than the designed distance and would therefore be difficult or impossible to insert.

In connectors in which one shield seals two or more terminal assemblies in a conductive housing, a shield may have multiple dimples, with at least one aligned with each such terminal assembly. Further, where multiple shields are used, such as in a multi-row connector, each shield may have one or more dimples. For example, though not visible n FIG. 14B, shield 1410 may have two dimples similar to dimples 1502 on shield 1300. Even in implementations in which a shield seals one terminal assembly in the conductive housing, the shield may have multiple dimples pressing against that terminal assembly, which may provide more uniform force on the terminal assembly. Having thus described several aspects of at least one embodiment of this invention, it is to be appreciated that various alterations, modifications, and improvements will readily occur to those skilled in the art.

For example, techniques described herein may be used in connectors having configurations other than those described above. For example, techniques described herein may be used in mezzanine connectors or in backplane connectors. Such alternative connector configurations may be used with all of the features described herein or a subset of any suitable number of features. Moreover, it should be appreciated that all of the structures, materials and construction techniques described herein may be used together, but, in some embodiments, some or all of the structures, materials or techniques may be omitted.

Such alterations or modifications are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

### EXAMPLES

In a first example, an electrical connector may include a conductive housing comprising a chamber; a terminal assembly disposed within the chamber, the terminal assembly comprising: a first insulative member; a second insulative member engaged with said first insulative member; and an electrical conductor comprising a mating contact portion, a contact tail, and an intermediate portion joining the mating contact portion and the contact tail, the electrical conductor comprising a first portion held, at least in part, by the first insulative member and a second portion held, at least in part, by the second insulative member, wherein the first insulative member and the second insulative member each comprise interlocking features configured to enable the second insulative member to slide relative to the first insulative member while the first insulative member and second insulative member are engaged.

Optionally, the second portion of the electrical conductor may be disposed between the second insulative member and the first insulative member.

In a second example, an electrical connector may include a conductive housing comprising a chamber; a terminal assembly disposed within the chamber, the terminal assembly comprising: an insulative housing comprising a first insulative member and a second insulative member; and an electrical conductor comprising a mating contact portion extending from the insulative housing in a first direction and a contact tail extending from the insulative housing in a second direction, and an intermediate portion joining the mating contact portion and the contact tail, the electrical conductor comprising a first portion held by the first insulative member and a second portion held between the first insulative member and the second insulative member; wherein the second insulative member comprises a channel, closed at the top, and the second portion of the electrical conductor is disposed within the channel.

In a third example, an electrical connector may include a conductive housing comprising a chamber; a shield member within and electrically and mechanically engaged to the conductive housing; a terminal assembly disposed within the chamber, the terminal assembly comprising: an insulative housing; and an electrical conductor held by the insulative housing; wherein said shield member comprises a dimple configured to engage with the insulative housing and provide force on the terminal assembly.

Optionally, the shield member may comprise a first side and a second side, opposite the first side; the dimple may extend from the first side; and the shield member may further comprise a compliant tab extending from the second side.

Optionally, the conductive housing may comprise a groove; and the compliant tab may be disposed at least in part within the groove such that the compliant tab biases the shield member towards the terminal assembly, whereby the shield member provides force on the terminal assembly.

Optionally, the insulative housing may comprise a first insulative member and a second insulative member; the electrical conductor comprising a mating contact portion extending from the insulative housing in a first direction and a contact tail extending from the insulative housing in a second direction, and an intermediate portion joining the mating contact portion and the contact tail, the electrical conductor comprising a first portion held by the first insulative member and a second portion held between the first insulative member and the second insulative member.

In a fourth example, an electrical connector may include a conductive housing comprising a chamber; a shield member within and releasably couplable electrically and mechanically to the conductive housing, the releasably couplable shield member separable from the conductive housing; a terminal assembly disposed within the chamber and releasably couplable to the conductive housing, the releasably couplable terminal assembly separate from the conductive housing, the terminal assembly comprising: a first insulative member; a second insulative member engaged with the first insulative member; and an electrical conductor comprising a mating contact portion, a contact tail, and an intermediate portion joining the mating contact portion and the contact tail, the mating contact portion extending from the first insulative member and the contact tail extending from the second insulative member, wherein the second insulative member comprises a channel, closed at the top, and the second portion of the electrical conductor is disposed within the channel.

Optionally, the mating contact portion may extend from the first insulative member in a first direction and the contact tail may extend from the second insulative member in a second direction.

Optionally, the first direction and the second direction may be substantially perpendicular.

Optionally, the electrical connector may further comprise a shield member within and electrically and mechanically engaged to the conductive housing; the second insulative member separating the shield member and the second portion of the electrical conductor.

Optionally, the shield may comprise a protrusion urging the second insulative member towards the first insulative member.

Optionally, the chamber may comprise an opening at a mating interface of the electrical connector; and the protrusion of the shield member may be configured to provide pressure on the terminal assembly.

Optionally, the chamber may comprise an opening at a mating interface of the electrical connector; and the pressure on the terminal assembly may urge the terminal assembly towards the mating interface.

Optionally, the second portion of the electrical conductor may be parallel to the contact tail.

Optionally, the second insulative member may comprise a channel; and at least a portion of the second portion of the electrical conductor may be disposed within the channel.

Optionally, the electrical connector may comprise a mating interface and the mating contact portion of the electrical conductor is disposed at the mating interface; and the electrical connector may comprise a mounting interface and the contact tail of the electrical conductor is disposed at the mounting interface.

Optionally, the channel may comprise a first end, adjacent the mounting interface and a second end opposite the first end; and the channel may be open at the first end and closed at the second end.

Optionally, the first insulative member may comprise an opening therethrough and the first portion of the electrical conductor is disposed withing the opening.

Optionally, the channel may comprise a first end, adjacent the mounting interface and a second end opposite the first end; the channel may be configured at the first end to slidably receive the second portion of the electrical conductor; and the channel may be configured at the second end to block sliding movement of the second portion of the electrical conductor out of the channel.

Optionally, the channel may comprise a first end, adjacent the mounting interface and a second end opposite the first end; the electrical conductor may further comprise a shoulder portion engaged in the channel at the first end. Optionally, the contact tail may be a press fit tail.

Optionally, the first insulative member and the second insulative member may comprise interlocking features; and the second insulative member may comprise a channel configured to slidingly receive the protrusion.

Optionally, the first insulative member may comprise a hole therethrough; the first portion of the electrical conductor may be disposed within the hole; and the mating contact portion of the electrical conductor may extend from the first insulative member.

Optionally, the first portion of the electrical conductor: may have a first width for over at least 50% of its length within the hole; may comprise a barb, with a second width wider than the first width, engaging the first insulative member; and may have a third width, narrower than the first width, proximate the barb.

Optionally, the conductive housing may comprise a wall within the chamber; the shield member may comprise retention barbs engaging the wall, whereby the shield member is positioned within the chamber of the conductive housing.

Optionally, the electrical connector may comprise a mounting interface; and the conductive housing may further comprise: a shelf adjacent the mounting interface; and a hole through the shelf.

Optionally, the electrical connector may further comprise a hold down, extending through the hole in the shelf and configured to retain the electrical connector to a printed circuit board (PCB).

Optionally, the shelf may have a first surface and a second surface at the mounting interface and opposite the first surface; the hold down comprising: a first end extending through the first surface of the shelf; and one or more barbs engaging the first surface of the shelf.

Optionally, the hold-down may comprise a second end, opposite the first end, configured to be press-fit into a hole of the PCB.

Optionally, the hold down may comprise a first compliant arm and a second compliant arm separated by an opening through the hold down, such that the hold down may be compressed for insertion through the hole in the shelf by deflection of the first arm and/or the second arm towards the opening.

Optionally, the electrical connector may further comprise: a second housing configured to be pushed onto the conductive housing in a mating direction.

Optionally, the first insulative member may comprise a first segment and a second segment transverse to the first segment; and the second insulative member may be engaged to the second segment of the first insulative member.

Optionally, the first insulative member may comprise an opening therethrough; the first portion of the electrical conductor may be disposed within the opening; the second insulative member may comprise a surface facing the second segment of the first insulative member; the second insulative member may comprise a channel recessed in the surface; and the second portion of the electrical conductor may be disposed within the channel.

Optionally, the electrical conductor may be a first electrical conductor; and the terminal assembly may comprise a second electrical conductor parallel to the first electrical conductor.

Optionally, the terminal assembly may be a first terminal assembly; and the electrical connector may comprise a second terminal assembly.

In a fifth example, an electrical connector may comprise: a conductive housing comprising a chamber and a shelf comprising a hole therethrough; a terminal assembly disposed within the chamber, the terminal assembly comprising: an insulative housing; and an electrical conductor comprising a mating contact portion extending from the insulative housing and a contact tail extending from the insulative housing, and an intermediate portion joining the mating contact portion and the contact tail; and a hold down comprising a first end engaged with the conductive housing and a second end extending from the insulative housing, wherein the first end extends through the hole and comprises a first compliant arm and a second compliant arm separated by an opening with a first barb extending from the first compliant arm and engaging the shelf.

Optionally, the hold down may further comprise: a second barb extending from the second compliant arm.

Optionally, the electrical connector may comprise a mounting interface; the conductive housing may further comprise: a shelf adjacent the mounting interface, and a hole through the shelf; the first end of the hold down extending through the hole through the shelf.

Optionally, the hold down may be configured to be compressed for insertion through the hole in the shelf by deflection of the first compliant arm and/or the compliant second arm towards the opening between the first compliant arm and the second compliant arm.

Optionally, the shelf may have a first surface and a second surface at the mounting interface and opposite the first surface; the first end of the hold down may extend through the first surface of the shelf; and the first barb and the second barb may engage the first surface of the shelf.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.c., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. An electrical connector, comprising:
a conductive housing comprising a chamber;
a terminal assembly disposed within the chamber, the terminal assembly comprising:
a first insulative member;
a second insulative member engaged with said first insulative member; and
an electrical conductor comprising a mating contact portion, a contact tail, and an intermediate portion joining the mating contact portion and the contact tail, the electrical conductor comprising a first portion held, at least in part, by the first insulative member and a second portion held, at least in part, by the second insulative member,
wherein the first insulative member and the second insulative member each comprise interlocking features configured to enable the second insulative member to slide relative to the first insulative member while the first insulative member and second insulative member are engaged.

2. The electrical connector of claim 1, wherein:
the second portion of the electrical conductor is disposed between the second insulative member and the first insulative member.

3. An electrical connector, comprising:
a conductive housing comprising a chamber;
a terminal assembly disposed within the chamber, the terminal assembly comprising:
an insulative housing comprising a first insulative member and a second insulative member; and
an electrical conductor comprising a mating contact portion extending from the insulative housing in a first direction and a contact tail extending from the insulative housing in a second direction, and an intermediate portion joining the mating contact portion and the contact tail, the electrical conductor comprising a first portion held by the first insulative member and a second portion held between the first insulative member and the second insulative member;
wherein the second insulative member comprises a channel, closed at the top, and the second portion of the electrical conductor is disposed within the channel.

4-5. (canceled)

6. The electrical connector as in claim 3, further comprising a shield member within and electrically and mechanically engaged to the conductive housing, wherein the shield member comprises a compliant tab, and
wherein:
the conductive housing comprises a groove; and
the compliant tab is disposed at least in part within the groove such that the compliant tab biases the shield member towards the terminal assembly, whereby the shield member provides force on the terminal assembly.

7-9. (canceled)

10. The electrical connector of claim 3, wherein:
the first direction and the second direction are substantially perpendicular.

11. The electrical connector of claim 1, wherein:
the electrical connector further comprises a shield member within and electrically and mechanically engaged to the conductive housing; and
the second insulative member separates the shield member and the second portion of the electrical conductor.

12-14. (canceled)

15. The electrical connector of claim 11, wherein:
the second portion of the electrical conductor is parallel to the contact tail.

16. The electrical connector of claim 1, wherein:
the second insulative member comprises a channel; and
at least a portion of the second portion of the electrical conductor is disposed within the channel.

17. The electrical connector of claim 16, wherein:
the electrical connector comprises a mating interface and the mating contact portion of the electrical conductor is disposed at the mating interface; and
the electrical connector comprises a mounting interface and the contact tail of the electrical conductor is disposed at the mounting interface.

18. The electrical connector of claim 17, wherein:
the channel comprises a first end, adjacent the mounting interface and a second end opposite the first end; and
the channel is open at the first end and closed at the second end.

19. The electrical connector of claim 18, wherein:
the first insulative member comprises an opening therethrough and the first portion of the electrical conductor is disposed withing the opening.

20. The electrical connector of claim 17, wherein:
the channel comprises a first end, adjacent the mounting interface and a second end opposite the first end;
the channel is configured at the first end to slidably receive the second portion of the electrical conductor; and
the channel is configured at the second end to block sliding movement of the second portion of the electrical conductor out of the channel.

21. The electrical connector of claim 17, wherein
the channel comprises a first end, adjacent the mounting interface and a second end opposite the first end;
the electrical conductor further comprises a shoulder portion engaged in the channel at the first end.

22. The electrical connector of claim 1, wherein the contact tail is a press fit tail.

23. (canceled)

24. The electrical connector of claim 3, wherein:
the first insulative member comprises a hole therethrough;
the first portion of the electrical conductor is disposed within the hole; and
the mating contact portion of the electrical conductor extends from the first insulative member.

25. The electrical connector of claim 24, wherein the first portion of the electrical conductor:
has a first width for over at least 50% of its length within the hole;
comprises a barb, with a second width wider than the first width, engaging the first insulative member; and
has a third width, narrower than the first width, proximate the barb.

26. (canceled)

27. The electrical connector of claim 1, wherein
the electrical connector comprises a mounting interface;
the conductive housing further comprises:
a shelf adjacent the mounting interface; and
a hole through the shelf.

28-31. (canceled)

32. The electrical connector of claim 1, further comprising:
a second housing configured to be pushed onto the conductive housing in a mating direction.

33. The electrical connector of claim 3, wherein:
the first insulative member comprises a first segment and a second segment transverse to the first segment; and
the second insulative member is engaged to the second segment of the first insulative member.

34. The electrical connector of claim 33, wherein:
the first insulative member comprises an opening therethrough;
the first portion of the electrical conductor is disposed within the opening;
the second insulative member comprises a surface facing the second segment of the first insulative member;
the second insulative member comprises a channel recessed in the surface; and
the second portion of the electrical conductor is disposed within the channel.

35-41. (canceled)
